(19) United States
(12) Patent Application Publication
(10) Pub. No.: US 2025/0203086 A1
(43) Pub. Date: Jun. 19, 2025

(54) IMAGE AND VIDEO CODING WIHT ADAPTIVE QUANTIZATION FOR MACHINE-BASED APPLICATIONS

(71) Applicant: OP Solutions LLC, Amherst, MA (US)

(72) Inventors: Hari Kalva, Boca Raton, FL (US); Borivoje Furht, Boca Raton, FL (US); Velibor Adzic, Canton, GA (US)

(73) Assignee: OP Solutions LLC, Amherst, MA (US)

(21) Appl. No.: 19/070,043

(22) Filed: Mar. 4, 2025

Related U.S. Application Data
(63) Continuation of application No. PCT/US2023/032030, filed on Sep. 6, 2023.
(60) Provisional application No. 63/404,272, filed on Sep. 7, 2022.

(51) Int. Cl. H04N 19/124

(52) U.S. Cl. CPC H04N 19/124

(57) ABSTRACT

A video coding system for machines employs adaptive quantization based on the frequency response of the machine model receiving the data. The encoder receives the machine model for the machine-based system and generates a frequency importance map from the machine model. An adjustment matrix is then generated based on the frequency importance map and is used to adjust coefficients of the default quantization matrix. The video data is quantized using the adjusted quantization matrix and encoded in a bitstream for transmission to a decoder site. At the decoder site, the decoder can extract parameters of the adjusted quantization matrix from the bitstream or calculate the adjusted quantization matrix using the machine model to inverse quantize the received data for machine consumption.

### STATEMENT OF RELATED APPLICATIONS

This application is a continuation of international application PCT/US23/32030 filed on Sep. 6, 2023, and titled “Image and Video Coding with Adaptive Quantization for Machine-based Applications,” which in turn claims priority to U.S. Provisional Application Ser. No. 63/404,272 filed on Sep. 7, 2022, titled “Image and Video Coding System with a Machine-based Adaptive Quantization.”

### BACKGROUND OF THE DISCLOSURE

A growing trend in video transmission is that a significant portion of images and videos that are recorded in the field are consumed by machines only, without ever reaching human eyes. Those machines process images and videos with the goal of completing specific tasks such as object detection, object tracking, segmentation, event detection, and the like. Recognizing that this trend is prevalent and will only accelerate in the future, international standardization bodies have been engaging in efforts to standardize image and video coding that is primarily optimized for machine consumption. For example, standards such as JPEG AI and Video Coding for Machines have been proposed in addition to already established standards such as Compact Descriptors for Visual Search, and Compact Descriptors for Video Analytics. Video and image data for machine consumption does not necessarily have the same requirements as human consumption. With the growing volume of data for machine consumption, solutions that improve efficiency for encoded data for machine consumption compared to classical image and video coding techniques are needed.

In classical image and video coding, hybrid systems are predominantly built using a workflow that includes: input pre-processing, partitioning, prediction, frequency transform, quantization, and entropy coding. Most of the steps result in so-called lossless compression, such that the output of the decoder can be identical to the input to the encoder. The only step that allows lossy compression is quantization. Here, the designer of the coding system can apply domain knowledge to remove redundant information from the input signal. In classical image and video coding systems, this is usually done by utilizing knowledge about the human visual system. For example, since the human visual system is more sensitive to low frequencies than high frequencies, quantization for human consumption is typically designed such that more information is preserved for low spatial frequencies. Such quantization strategies, however, may lead to sub-optimal results when humans are replaced by machines as the end users. Depending on the task, machines may be sensitive to any portion of the spectrum. An adaptive strategy when designing quantization may provide enhanced performance and efficiency.

### SUMMARY OF THE DISCLOSURE

Systems and methods for image and video coding are presented which include an encoder and a decoder. The present systems and methods are preferably applied to use cases where machines are processing the output of the decoder. The present methods preferably include a method for adaptive quantization that is tailored for improved performance in the tasks that a machine conducts on the output of the decoder. The present systems and methods improve efficiency of the image and video coding compared to widely used systems that apply classical coding techniques developed for human end users.

In one embodiment, a system is comprised of the encoder, which encodes image and/or video using the proposed quantization method and a decoder which decodes encoded image and/or video using the information provided by the encoder in the bitstream or applies additional method for post-processing quantization independently of the encoded bitstream information.

An adaptive quantization module (AQM) for encoding and decoding image or video data for machines using adaptive quantization will preferably obtain a machine model for the machine-based system receiving the image and/or video data. From this machine-model, the AQM will generate a frequency importance map. The frequency importance map is used to determine an adjustment matrix, which in turn is used to adjust the default quantization matrix. The AQM quantizes the image or video data using the adjusted quantization matrix.

In some embodiments, the frequency importance map is implicitly determined from the machine model by iteratively testing the sensitivity of the model output to the changes in each frequency band of interest. This may include testing of the frequency sensitivity of the machine model using a gradient method which is based on the chain rule for differentiation.

Alternatively, the frequency importance map may be implicitly determined using statistics of the sample dataset on which the machine model is trained.

The AQM preferably adjusts the default quantization matrix by calculating a Hadamard product of the default quantization matrix and the adjustment matrix.

Preferably, a video coding system for machines includes an encoder with an AQM and a compliant decoder with a compatible AQM. In some embodiments, the AQM at the encoder site generates the adjusted quantization matrix and encodes parameters of the matrix in the bitstream. In this case, the AQM at the decoder can extract the parameters from the bitstream to perform inverse quantization.

While the option of adaptive quantization is available for the machine—targeted coding, the system allows flexibility of using classical quantization, when needed—as an example, for hybrid use case where both machine and human are consumers of the decoded video, as extracted from the bitstream or sub-streams within a bitstream.

### BRIEF DESCRIPTION OF THE FIGURES

FIG. 1 is a block diagram of an encoder and decoder system in accordance with the present disclosure;

FIG. 2 is a flow chart illustrating an adaptive quantization method in accordance with the present disclosure;

FIGS. 3A and 3B illustrate a matrix of picture block pixels and transformed block coefficients, respectively, in accordance with an embodiment of the present disclosure;

FIGS. 4A, 4B, and 4C illustrate a default quantization matrix M, the calculated adjustment factors F, and the resulting adaptive quantization matrix MA, respectively, in an exemplary 4×4 matrix;

FIG. 5 is a block diagram illustrating an exemplary decoder suitable for use in the practice of the present systems and methods;

FIG. 6 is a block diagram illustrating an exemplary encoder suitable for use in the practice of the present systems and methods; and

FIG. 7 is a simplified block diagram of exemplary general purpose computing device capable of being programmed and configured for performing the present systems and methods.

### DETAILED DESCRIPTION OF EXEMPLARY EMBODIMENTS

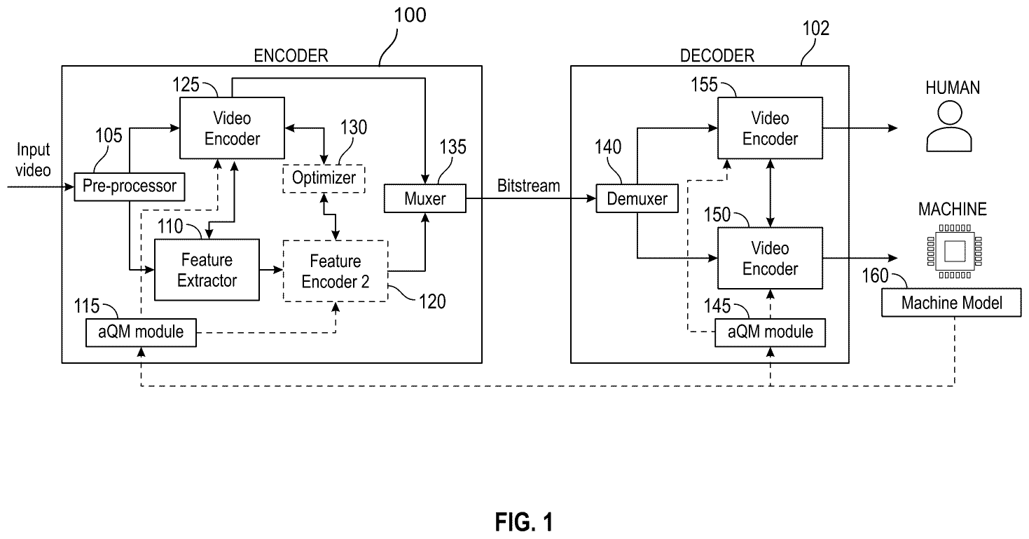

FIG. 1 is a simplified block diagram illustrating a system for encoding and decoding data in accordance with the present disclosure. Input image/video is encoded by encoder 100 includes a pre-processor 105, which converts the input signal into appropriate modality and format. Examples include color space conversion from RGB to YCbCr, frame-rate downsampling, resolution rescaling, etc. The pre-processor 105 provides an output to feature extractor 110, which can be used to extract machine-relevant portions of the spatial and temporal information. Examples include, edge detection, feature map extraction, keypoint extraction, etc. Video Encoder(s) 120, 125, are provided which use hybrid image/video coding with the proposed adaptive quantization method to produce bitstreams. Optionally, optimizer 130 is provided and can negotiate redundancy minimization between the encoders 120, 125. For example, if video encoder 120 is encoding edges, and other low-level elements of the image/video (as a base layer), the video encoder 125 can be configured to encode the remaining visual information (as additive layer). In such a use case, at the decoder side, after decoding the base layer, the additive layer is decoded and added to the base layer to reproduce the complete visual information.

Muxer 135 is a multiplexer that combines two or more sub-streams into a unified bitstream that is sent to the decoder. Thus, muxer 135 receives the outputs from video encoder 120 and video encoder 125 to generate the resultant bitstream from the encoder 100.

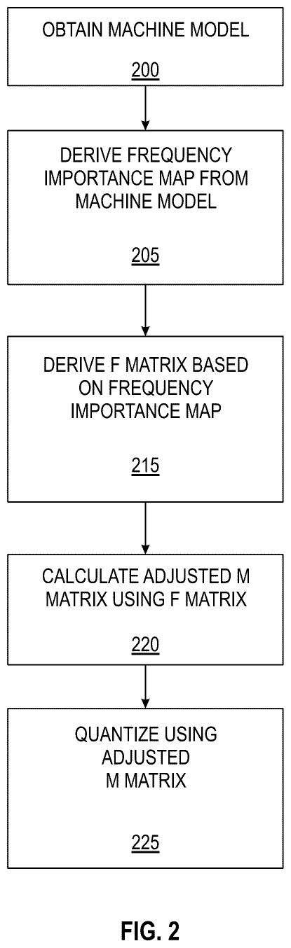

The encoder further includes an adaptive quantization module aQM module 115, which calculates adaptive quantization matrix based on the machine model 160 and passes the calculated values to the video encoder(s) 120, 125. The adaptive quantization methods employed by aQM module 15 are discussed in further detail below and depicted in the high-level flow chart of FIG. 2.

The encoded video bitstream is provided over a communication channel to decoder 102. Demuxer 140 receives the bitstream and de-multiplexes the sub-streams from the bitstream and sends them to the appropriate video decoder. Video decoder(s) 150, 155, which decode the image/video using the information in the bitstream. Optionally, the video decoders can implement the proposed adaptive quantization method for encoder-independent post-processing.

An aQM module 145 is provided in the decoder 102 to calculate an adaptive quantization matrix based on the machine model 160 and passes the calculated values to the video decoder(s) 150, 155 to implement adaptive quantization. Alternatively, the aQM module 145 receives parameters for the adaptive quantization matrix calculated by the encoder and which are signaled in the received bitstream.

In addition to the encoder 100 and the decoder 102, a machine model 160 can be stored or transmitted to the encoder 100 and the decoder 102. This machine model 160 preferably contains relevant information about the machine algorithm. This information can be used to calculate proper quantization adjustments.

### Adaptive Quantization Method

In classical image/video coding, pixels that represent either the input signal or the residual from the prediction process are transformed into frequency coefficients using some variant of Discrete Cosine Transform, Discrete Sine Transform, Wavelet Transform, or similar transformations. The reason is found in the energy compaction and decorrelation properties of those transforms. In the image/picture pixel block, the energy is distributed nearly uniformly across the block. After transformation, the data has been decorrelated horizontally and vertically and one dominant coefficient now contains a significant proportion of the energy.

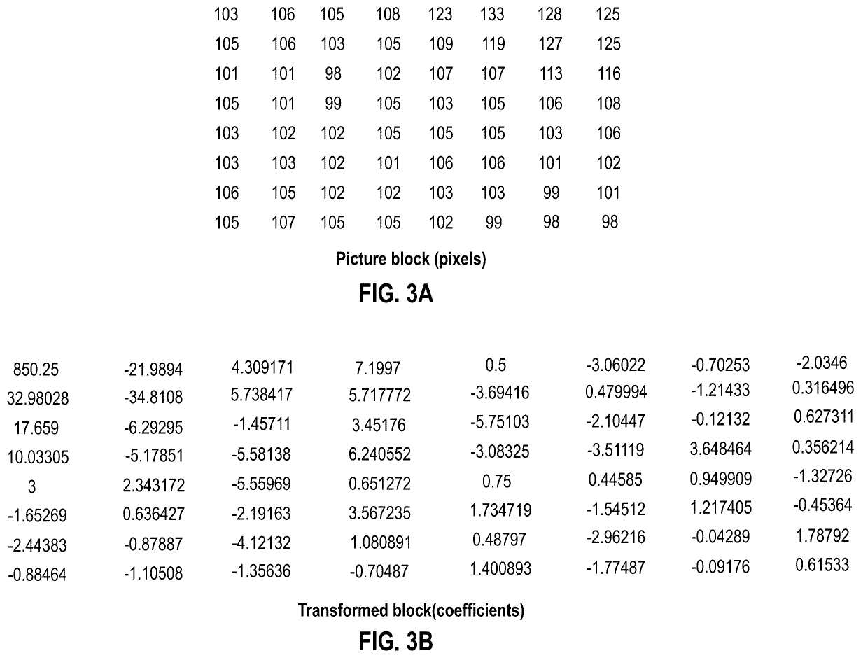

For example, an 8×8 picture block of pixels and the DCT-II transformed coefficients is given in FIGS. 3A and 3B, respectively. With reference to FIGS. 3A and 3B, the coefficients with significant values are predominantly located near the top left portion of the matrix, which corresponds to the low frequency. Most of the values near the bottom right are so small that they can be set to zero without a significant impact on reconstruction quality. This is reflected in the quantization matrix design, where values on the bottom right are usually higher than the values in the top left. The reason this is near-optimal design is found in the characteristics of the human visual system which is not sensitive to artifacts in the high frequency areas of the image/picture.

However, machines often process visual information based on principles that differ from the human visual system in significant ways. Distortions in the high frequency portion of the spectrum (which correspond to highly textured portions of the image/picture) can result in a significant degradation of accuracy in completing the given machine task. The sensitivity of a particular machine to different portions of the input spectrum is not readily apparent and generally has to be calculated based on the machine model parameters.

The method of adaptive quantization processing in accordance with the present disclosure is generally illustrated in FIG. 2. The method is used to adjust a default quantization matrix M to the frequency response of the machine model, thereby providing quantization that is both efficiently compressed and well suited for conveying information to the machine-based system receiving the data. At a high level, the method includes the steps of obtaining the machine model (step 200) and using this model to derive a frequency importance map (step 205). The frequency importance map can be used to adjust the M matrix. The machine model and frequency importance map can be used to derive an F matrix (step 215) which in turn is used to calculate the adjusted quantization matrix, MA (Step 220). The adjusted quantization matrix, MA, is then used to quantize the data (step 225) at the encoder side for transmission over a channel and subsequent decoding at the machine site. The adjusted quantization matrix, MA, is also preferably signaled in the bitstream for inverse quantization at the decoder.

### Calculation of the Adaptive Quantization Matrix

The transformed coefficients matrix T is quantized such that each value is divided by the corresponding value in the quantization matrix M:

$$Q = T ∘ 1 / M$$

Where ° represents a Hadamard product of matrices T_{N×N} and M_{N×N}, resulting in the quantized coefficient matrix Q_{N×N}. With optimal values, the matrix M can achieve optimal rate-distortion performance. However, the definition of the distortion measure changes when the end user is not human, but rather is a machine performing a specific task that it's trained for. With the present adaptive quantization method, the values in matrix M are calculated such that the resulting matrix Q achieves highest performance in task completion with the lowest amount of data. Thus, it is preferable to compute M such that it reflects the importance mapping of the machine model, as illustrated in FIG. 2.

Referring to FIG. 2, in step 200, information about the machine model is obtained. Information about the machine model 160 can be obtained explicitly or implicitly. Machine model information may include, for example, type and size of the objects of interest to the decoder. For example, if the machine-task detects faces and license plates, it may be desirable to preserve details and hence the higher frequency coefficients (e.g., the coefficients at the bottom right of the FIG. 2B and FIG. 3A) should not be significantly quantized. On the other hand, if the machine-task requires less detail, e.g., if it detects the presence of cars, then the higher frequency coefficients may not be as important. Another example of machine model information is the type of task. For detection tasks, higher frequency coefficients might be important, whereas for tracking tasks they are typically less important. Another consideration is the characteristics of the dataset that is used to train the detection/tracking network. For example, if the training dataset used JPEG images, then it is preferable to match the quantization to the one that is used in default JPEG settings, etc.

Explicit information can be provided from the designer who built and configured the machine model 160. This information has direct and explicit mapping to the quantization, which is trivial. Here, we are considering implicit deduction which can be performed from the training sample or from the model parameters.

The spectral domain information is represented by the transform coefficients. The magnitude of the coefficients corresponds to the importance of the given frequency. The information most pertinent to the machine model is the one preserved in the coefficients after the quantization. The dynamic range of all the coefficients at a given frequency, given by the energy, or a variance of all the samples, represents the importance of the given frequency. Because of this, the machine-optimized quantization should preserve frequencies that have higher importance to the machine model and reduce or remove the less important frequencies.

In step 205, a frequency importance map can be derived for the machine model. To determine the frequency importance map for a given machine model, two implicit techniques can be used. First, the mapping can be obtained from the model itself using a technique that is equivalent to backpropagation. The sensitivity of the model output to the changes in each frequency band can be tested using a gradient method, which is based on the chain rule for differentiation. If the output loss function of the machine model is given as L, and the input to the model is given as X, the differentiation chain gives the following relationship:

$$\frac{\partial L}{\partial X} = \frac{\partial L}{\partial {X}_{n}} \times \frac{\partial {X}_{n}}{\partial {X}_{n - 1}} \times \frac{\partial {X}_{n - 1}}{\partial {X}_{n - 2}} \times … \times \frac{\partial {X}_{1}}{\partial X}$$

Where each Xₙ is the output of the n-th layer of the neural network. Since the input X is obtained by dequantizing the quantized frequency coefficients in Q, further expansion of the chain relates to the derivative (or gradient in the case of matrices):

$$\frac{\partial X}{\partial Q}$$

This derivative will determine the sensitivity of the model, represented by the loss function L, to changes in each quantized coefficient.

Using this information, the default quantization matrix M can be adjusted, such that the elements M_{i,j} corresponding to the elements Q_{i,j} with the highest gradient are proportionally decreased and vice versa. If the backpropagation method is not available or not easily computable, an alternative implicit technique is to use the statistics of the sample dataset on which the model is trained. The rationale for using training set statistics is justified by the fact that model's sensitivity is correlated with the variance of the training samples. In other words, and in general terms, the model will recognize new inputs that are within the dynamic range of the training samples, while the inputs that are outside of the range of learning samples will be prone to misclassification.

In step 215, an adjustment factor matrix, F, is determined. The calculation of the correlation between training and new samples is preferably performed in the frequency domain. For each frequency coefficient position i,j the variance quotient can be calculated and stored as an adjustment factor. For example,

$${F}_{i , j} = {k}_{i , j} \times \frac{Var ( {T}_{i , j}^{′} )}{Var ( {T}_{i , j} )}$$

T′_{i,j} is the coefficient in the transformed new sample, and T_{i,j} is the coefficient in the transformed training sample at the same frequency. The T's are calculated as averages of all the coefficients at the given frequency in the dataset. An additional coefficient k is introduced as a multiplying factor that can be adjusted based on the specific use case to control the rate, and in the default case it has a value 1.

The final value of the adaptive quantization matrix MA is obtained by calculating a Hadamard product of the default matrix M and the adjustment factors matrix F.

$${M}_{A} = M ∘ F$$

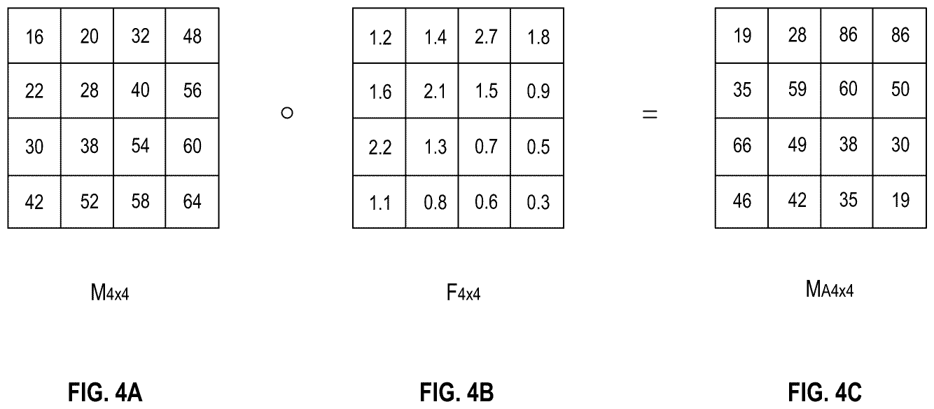

An example of the default quantization matrix M, the calculated adjustment factors F, and the resulting adaptive quantization matrix MA are given in FIGS. 4A, 4B, and 4C, respectively. As can be seen, the adaptive quantization values have a different distribution than the default quantization values, with less uniform frequency-importance direction. For ease of illustration, the example given in FIG. 4A-4C depicts 4×4 matrices, but the method is applicable to any N×N or N×K matrix, where N and K are positive integers.

While the given examples describe machine models based on neural networks, similar methodology can be applied to other models based on different statistical learning techniques. Values for the adaptive quantization matrix can be calculated each time machine model is updated. For example, this can be done once when the system is initialized based on the starting parameters of the machine model and then repeated each time machine model is updated. The updates can be passed to the aQM modules, which recalculate matrix values. Updates to the machine model 160 might be initiated based on the re-training of the existing model or replacement of the model with a new model, either using the same machine framework reappropriated/retrained for the new task, or replacement of the whole framework. Adaptive quantization is a universal process that does not depend on a particular configuration or dimensionality of the machine model.

Regarding the operation of the aQM module in the decoder, it is important to note its role of post-processing. The output of the decoder process is typically a pixel representation of the coded signal. Since formulas for calculating sensitivity of the model to the input signal can be applied either in the pixel domain (X), or extended to the quantized domain (Q), the post-processing can be done either directly on the decoder output in the pixel domain, or the decoder output can be transformed into frequency domain, quantized, and then de-quantized into the pixel domain. In both cases, the resulting pixel representation is expected to produce better performance, in the sense of accuracy, when passed into the machine model.

### Bitstream

The bitstream is generally comprised of the standard elements such as stream header, sub-stream headers, and payload information. The signaling of the adaptive quantization matrix can be signaled in the bitstream such as by using the picture header. The parameters can be specified on the lowest, block-level.

Each Image/picture header can contain adaptive quantization parameters in the following format:

| Block ID | AQ Deltas |
|---|---|
| 10 | [1.2, 1.4, 2.7, 1.8, 1.6, 2.1, 1.5, 0.9, 2.2, 1.3, 0.7, |
| | 0.5, 1.1, 0.8, 0.6, 0.3] |
| 11 | [0.0, 0.2, 0.1, 1.2, 1.2, 0.4, 0.2, 0.0, 0.0, 0.0, 0.2, |
| | 0.4, −0.2, −0.4, 0.0, 0.1] |
| . . . | . . . |

Block ID represents the identification number of the prediction block (i.e. block in the image coding, macroblock or a coding unit in the video coding) in the current image/picture. The AQ deltas represent the elements of the adjustment matrix M. The elements are encoded as the values for the first block, and as the difference values for each subsequent block. For example, to obtain element values for the second block, values of the first block, from the first row are added to the values of the difference (deltas) from the second row.

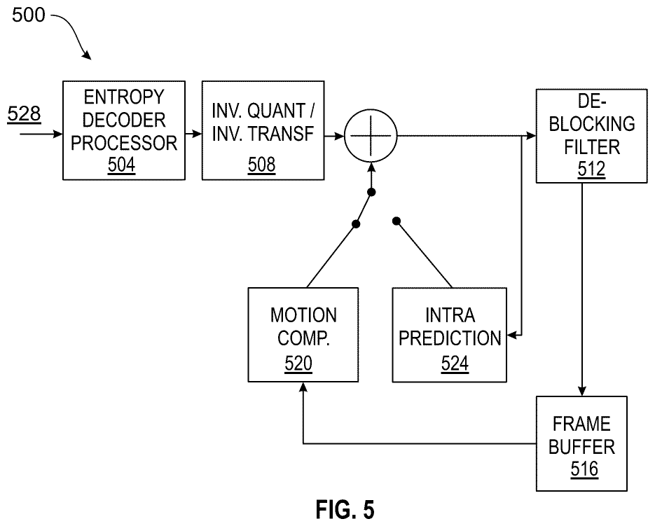

FIG. 5 is a system block diagram illustrating an example of a decoder suitable for use as video decoder 155 and/or feature decoder 150. Decoder 500 may include an entropy decoder processor 504, an inverse quantization and inverse transformation processor 508, a deblocking filter 512, a frame buffer 516, a motion compensation processor 520 and/or an intra prediction processor 524.

In operation, and still referring to FIG. 5, bit stream 528 may be received by decoder 500 and input to entropy decoder processor 504, which may entropy decode portions of bit stream into quantized coefficients. Quantized coefficients may be provided to inverse quantization and inverse transformation processor 508, which may perform inverse quantization and inverse transformation to create a residual signal, which may be added to an output of motion compensation processor 520 or intra prediction processor 524 according to a processing mode. An output of the motion compensation processor 520 and intra prediction processor 524 may include a block prediction based on a previously decoded block. A sum of prediction and residual may be processed by deblocking filter 512 and stored in a frame buffer 516.

In an embodiment, and still referring to FIG. 5, decoder 500 may include circuitry configured to implement any operations as described above in any embodiment as described above, in any order and with any degree of repetition. For instance, decoder 500 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Decoder 500 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

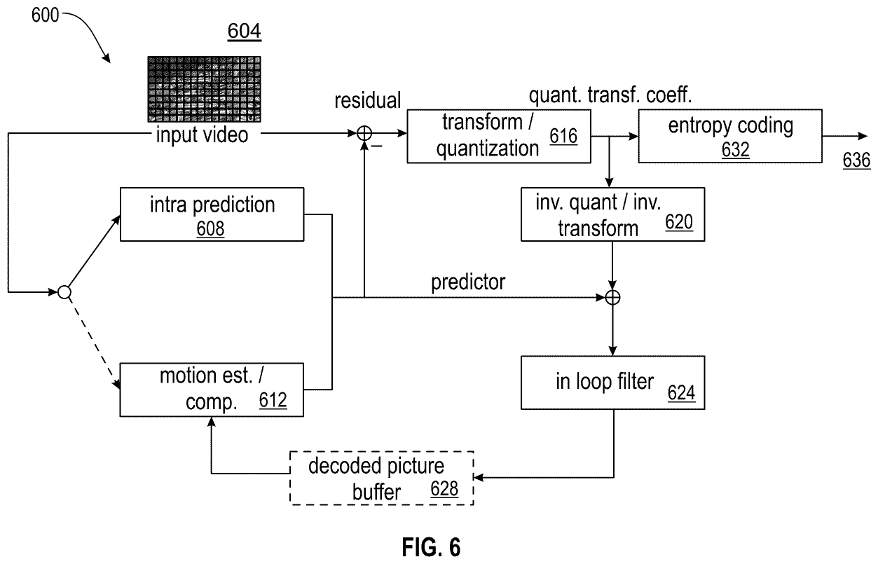

FIG. 6 is a system block diagram illustrating an exemplary embodiment of a video encoder 600, suitable for use as video encoder and/or feature encoder. Exemplary video encoder 600 may receive an input video 604, which may be initially segmented or divided according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A result of this portioning may include a group of sub-blocks that may be called predictive units (PU). Transform units (TU) may also be utilized.

Still referring to FIG. 6, example video encoder 600 may include an intra prediction processor 608, a motion estimation/compensation processor 612, which may also be referred to as an inter prediction processor, capable of constructing a motion vector candidate list including adding a global motion vector candidate to the motion vector candidate list, a transform/quantization processor 616, an inverse quantization/inverse transform processor 620, an in-loop filter 624, a decoded picture buffer 628, and/or an entropy coding processor 632. Bit stream parameters may be input to the entropy coding processor 632 for inclusion in the output bit stream 636.

In operation, and with continued reference to FIG. 6, for each block of a frame of input video, whether to process block via intra picture prediction or using motion estimation/compensation may be determined. Based on this determination, a block may be provided to intra prediction processor 608 or motion estimation/compensation processor 612. If block is to be processed via intra prediction, intra prediction processor 608 may perform processing to output a predictor. If block is to be processed via motion estimation/compensation, motion estimation/compensation processor 612 may perform processing including constructing a motion vector candidate list including adding a global motion vector candidate to the motion vector candidate list, if applicable.

Further referring to FIG. 6, a residual may be formed by subtracting a predictor from input video. Residual may be received by transform/quantization processor 616, which may perform transformation processing (e.g., discrete cosine transform (DCT)) to produce coefficients, which may be quantized. Quantized coefficients and any associated signaling information may be provided to entropy coding processor 632 for entropy encoding and inclusion in output bit stream 836. Entropy encoding processor 632 may support encoding of signaling information related to encoding a current block. In addition, quantized coefficients may be provided to inverse quantization/inverse transformation processor 620, which may reproduce pixels, which may be combined with a predictor and processed by in loop filter 624, an output of which may be stored in decoded picture buffer 628 for use by motion estimation/compensation processor 612 that is capable of constructing a motion vector candidate list including adding a global motion vector candidate to the motion vector candidate list.

With continued reference to FIG. 6, although several variations have been described in detail above, other modifications or additions are possible. For example, in some implementations, current blocks may include any symmetric blocks (8×8, 16×16, 32×32, 64×64, 128×128, and the like) as well as any asymmetric block (8×4, 16×8, and the like).

In some implementations, and still referring to FIG. 6, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit level, a joint-classifier decision tree structure may eliminate unnecessary iterations and control the risk of false prediction. In some implementations, LTR frame block update mode may be available as an additional option available at every leaf node of QTBT.

In some implementations, and still referring to FIG. 6, additional syntax elements may be signaled at different hierarchy levels of a bitstream. For example, a flag may be enabled for an entire sequence by including an enable flag coded in a Sequence Parameter Set (SPS). Further, a CTU flag may be coded at a coding tree unit (CTU) level.

Some embodiments may include non-transitory computer program products (i.e., physically embodied computer program products) that store instructions, which when executed by one or more data processors of one or more computing systems, cause at least one data processor to perform operations herein.

Still referring to FIG. 6, encoder 600 may include circuitry configured to implement any operations as described above in any embodiment, in any order and with any degree of repetition.

For instance, encoder 600 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder 600 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 6, non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder and/or encoder may be configured to perform. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

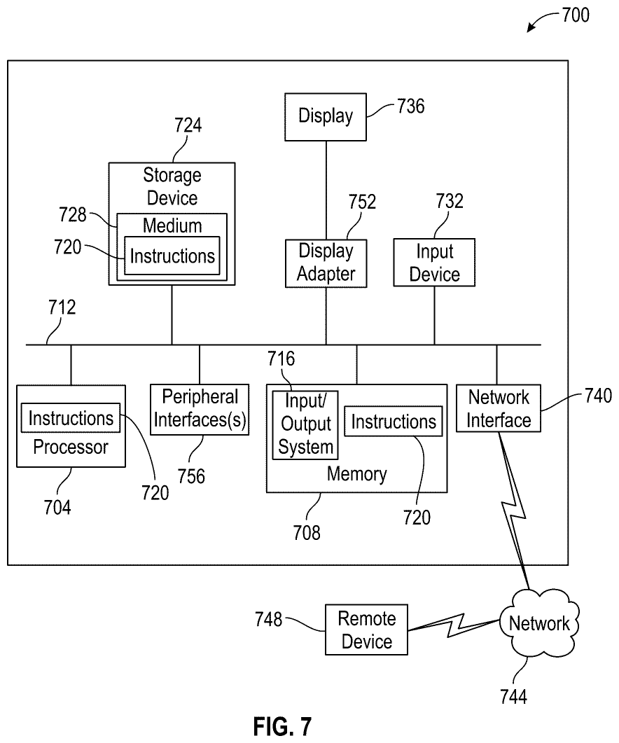

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC)

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A video encoder for encoding video data for machines using adaptive quantization, the encoder including a quantization processor having a default quantization matrix and performing the steps comprising:
obtaining a machine model for the machine-based system receiving the video data;
generate a frequency importance map from the machine model;
determine an adjustment matrix based on the frequency importance map;
adjust the default quantization matrix using the adjustment matrix; and
quantize the video data using the adjusted quantization matrix.

2. The encoder of claim 1, wherein the frequency importance map is implicitly determined from the machine model by iteratively testing the sensitivity of the model output to the changes in each frequency band of interest.

3. The encoder of claim 2, wherein the testing of the frequency sensitivity of the machine model further comprises using a gradient method which is based on the chain rule for differentiation.

4. The encoder of claim 1, wherein the frequency importance map is implicitly determined using statistics of the sample dataset on which the machine model is trained.

5. The encoder of claim 1, wherein adjusting the default quantization matrix comprises calculating a Hadamard product of the default matrix and the adjustment matrix.

6. An adaptive quantization module for encoding or decoding video data, the adaptive quantization module having a processor programmed to perform an adaptive quantization method, comprising:
obtaining a machine model for the machine-based system receiving the video data;
generate a frequency importance map from the machine model;
determine an adjustment matrix based on the frequency importance map;
adjust the default quantization matrix using the adjustment matrix; and
quantize the video data using the adjusted quantization matrix.

7. The adaptive quantization module of claim 6, wherein the frequency importance map is implicitly determined from the machine model by iteratively testing the sensitivity of the model output to the changes in each frequency band of interest.

8. The adaptive quantization module of claim 7, wherein the testing of the frequency sensitivity of the machine model further comprises using a gradient method which is based on the chain rule for differentiation.

9. The adaptive quantization module of claim 6, wherein the frequency importance map is implicitly determined using statistics of the sample dataset on which the machine model is trained.

10. The adaptive quantization module of claim 6, wherein adjusting the default quantization matrix comprises calculating a Hadamard product of the default matrix and the adjustment matrix.

11. A decoder for decoding a video bitstream for machine consumption, the decoder having an adaptive quantization module programmed to perform inverse quantization of a bitstream encoded with an adaptive quantization method, the inverse quantization comprising:
obtaining a machine model for the machine-based system receiving the video data;
generate a frequency importance map from the machine model;
determine an adjustment matrix based on the frequency importance map;
adjust the default quantization matrix using the adjustment matrix; and
inverse quantize the video data using the adjusted quantization matrix.

12. The decoder of claim 11, wherein the frequency importance map is implicitly determined from the machine model by iteratively testing the sensitivity of the model output to the changes in each frequency band of interest.

13. The decoder of claim 12, wherein the testing of the frequency sensitivity of the machine model further comprises using a gradient method which is based on the chain rule for differentiation.

14. The decoder of claim 11, wherein the frequency importance map is implicitly determined using statistics of the sample dataset on which the machine model is trained.

15. The decoder of claim 11, wherein adjusting the default quantization matrix comprises calculating a Hadamard product of the default matrix and the adjustment matrix.
